(19) United States
(12) Patent Application Publication
(10) Pub. No.: US 2019/0344265 A1
(43) Pub. Date: Nov. 14, 2019

(54) Networked Cell Holder Chip

(71) Applicant: Lidong Qin, Houston, TX (US)

(72) Inventors: Lidong Qin, Houston, TX (US); Myeong Chan Jo, Houston, TX (US); Joon Hee Jang, Katy, TX (US); Yuan Ma, Toronto (CA)

(73) Assignee: Lidong Qin, Houston, TX (US)

(21) Appl. No.: 16/406,723

(22) Filed: May 8, 2019

Related U.S. Application Data
(60) Provisional application No. 62/668,606, filed on May 8, 2018.

(51) Int. Cl. B01L 3/00

(52) U.S. Cl. CPC B01L 3/50857; B01L 2200/0652; B01L 3/502753; B01L 3/502761; B01L 2200/0621; B01L 2200/10; B01L 2200/028; B01L 2300/0609; B01L 2300/0819; B01L 2300/0829; B01L 2300/0858; B01L 2300/087; B01L 2300/168; B01L 2300/0851; B01L 2200/021; B01L 3/502715

(57) ABSTRACT

A cell holder chip is provided, comprising a top layer having a plurality of spaced apart microwells and a plurality of microchannels, each microwell being open on top and configured to hold a single cell, and each microwell being connected to at least two nearby microwells via respective microchannels. The microchannels are sized to enable protrusions from the cells to spread therethrough and have widths smaller than the cells to preventing the cells from entering the microchannels.

### CROSS-REFERENCES TO RELATED APPLICATIONS

This application claims priority from U.S. Provisional Application Ser. No. 62/668,606 filed May 8, 2018, which is hereby incorporated herein by reference in the respective in its entirety.

### TECHNICAL FIELD

This invention relates to the field of biology, and more particularly, to devices for holding single cells for enabling experiments to be performed in the cells.

### BACKGROUND OF THE INVENTION

High-throughput screening (HTS), driven by the great progress in automation technology and combinatorial chemistry, has been widely implemented in drug discovery. As increasing considerations of earlier stage ADMET (absorption, distribution, metabolism, excretion and toxicity) in drug development, cell-based HTS is highly recommended in modern drug discovery for its ability to detect more biologically relevant characteristics of compounds in living systems.

The conventional cell-based screening is based on cell proliferation/cytotoxicity assays, monitoring the overall growth or death of a population of cells in response to treatment with specific compounds. However, conventional cell-based screening is riddled by long response times, which span from days to weeks for the whole assay time, and the possibility of interference from other intracellular pathways. In addition, current readout data from HTS are population based and does not represent the uniqueness of an individual single cell or of important sub populations, such as cancer stem cells. Since identification of the mechanism of action of a drug candidate in the cellular level is a key step stone for screening small molecules acting on therapeutic target protein or pathway, single cell observation is a key to successful drug development. Importantly, there is a lack of an effective assay method in cell-based HTS to selectively identify novel inhibitors for metastasis, though metastasis accounts for more than 90% of mortality.

Moreover, research efforts have focused on finding the molecular mechanisms underlying the bystander effect, with most studies focusing on the role of connexins and gap junctions. Treating cells and observing the behavior of adjacent cells have been the general methods used to dissect the mechanism of the bystander effect. However, researching the bystander effect at the single-cell level is a more recent trend that can uncover biological signals without the influence of uncertain elements associated with the complex structure and organization of neural networks.

To date, photoreceptor bystander research is fraught with technical challenges, including difficulties in dissociating retinal structures and quantitatively measuring bystander killing speed, unclear observations, and the lack of a reliable single-cell assay. Thus, the ability to observe and quantify the bystander killing effect in cone photoreceptors is instrumental for further mechanistic research.

### BRIEF SUMMARY OF EMBODIMENTS OF THE INVENTION

To address the limitations of population based HTS and the current microinjection techniques, it would be advantageous to have a device for holding single cells separately to enable experiments on each single cell.

An aspect of some embodiments of the present invention relates to a cell holder chip, which comprises a top layer having a plurality of spaced apart microwells and a plurality of microchannels, each microwell being open on top and configured to hold a single cell, and each microwell being connected to at least two nearby microwells via respective microchannels. The microchannels are sized to enable protrusions from the cells to spread therethrough and have widths smaller than the cells to preventing the cells from entering the microchannels.

In a variant, the top layer is transparent to visible light.

In another variant, the cell holder chip further comprises a substrate bonded to a bottom of the top layer.

In yet another variant, the substrate is rigid.

In a further variant, the substrate is made of material that is transparent to visible light.

In yet a further variant, the microchannels are open on both the top and bottom of the top layer, and the substrate closes the microchannels at the bottom of the top layer.

In a variant, the cell holder chip further comprises a bottomless well plate joined to a top of the top layer, the bottomless well plate comprising a plurality of wells that traverse the plate vertically and are open both on the top and bottom of the bottomless well plate, the wells being configured to hold a liquid solution which includes cells that are to be captured in the microchannels and to enable transfer of the solution to the microwells.

In another variant, each microwell is connected to two nearby microwells via respective microchannel; or each microwell is connected to four nearby microwells via respective microchannel; or each microwell is connected to six nearby microwells via respective microchannel; or each microwell is connected to eight nearby microwells via respective microchannel.

In yet another variant, the microwells are set into an array of parallel rows, and the microchannels are straight channels connecting microwells in the same column and/or in the same row.

In a further variant, at least one of the microwells has a top cross-section has a perimeter which includes at least one inner concave angle and at least one inner convex angle, for providing increased friction between the microwell and the cell contained within.

In some embodiments of the present invention, the at least one inner convex angle is acute.

In yet a further variant, the at least one of the microwells has the top cross-section has the perimeter which includes a plurality of inner concave angles and a plurality of inner convex angle, such that a plurality of extensions are formed, protruding inward from the perimeter, to provide increased friction between the microwell and the cell contained within.

In some embodiments of the present invention, at least one of the inner convex angles is acute.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 is a side cross sectional view of a networked cell-holder chip with up-open microwells, according to some embodiments of the present invention;

FIG. 2 is a side cross sectional view of a networked cell-holder chip with microwells are open both on the top and bottom, and the bottoms of the microwells are closed by the substrate, according to some embodiments of the present invention;

FIG. 3 is an exploded view of a networked cell-holder chip of some embodiments of the present invention, bonded to a bottomless well plate and configured to receive a solution from the bottomless well plate;

FIG. 4 is a top view of a networked cell-holder chip of the present invention in which each microwell is connected to four nearby microwells via respective microchannels;

FIG. 5 is a top view of a networked cell-holder chip of the present invention in which each microwell is connected to six nearby microwells via respective microchannels;

FIG. 6 is a top view of a networked cell-holder chip of the present invention in which each microwell is connected to two nearby microwells via respective microchannels;

FIGS. 7-13 illustrate steps of a method for fabricating a networked cell-holder chip, according to some embodiments of the present invention;

FIG. 14 is a top view of a photomask used in the fabrication of the networked cell-holder chip, according to some embodiments of the present invention;

FIG. 15 is top view illustrating the completed networked cell-holder chip, according to some embodiments of the present invention;

FIGS. 16-19 illustrates steps of a method for treating the networked cell-holder chip for adhesion of cells, according to some embodiments of the present invention;

FIG. 20 illustrates a swinging bucket rotor having receptors upon which the chips and bottomless well plates are loaded, according to some embodiments of the present invention;

FIG. 21 illustrates the swinging bucket rotor joined to a centrifuge configured to control the rotation of the swinging bucket rotor, according to some embodiments of the present invention;

FIG. 22 illustrates an imaging system configured for monitoring the cells in the chip, according to some embodiments of the present invention;

FIGS. 23-25 are photographs of representative fluorescence and bright images of captured GFP transfected cells in the chip of the present invention;

FIGS. 26a-26e are time course images of breast cancer cells in the chip of the present invention, illustrating the development of the protrusions when the breast cancer plates are left untreated;

FIGS. 27a-27e are time course images of breast cancer cells in the chip of the present invention, illustrating the reduction of the protrusions when the breast cancer cells are treated with an anti-cancer drug (paclitaxel);

FIG. 28 is a graph illustrating normalized length of cell protrusion of untreated breast cancer cells over time;

FIG. 29 is a graph illustrating normalized length of cell protrusion of breast cancer cells treated with an anti-cancer drug (paclitaxel) over time;

FIGS. 30-33 illustrate examples of shapes of microwells in the chip for increasing friction between the microwell and the cell contained within, according to some embodiments of the present invention;

FIGS. 34-36 are photographs illustrating a microinjection performed on a cell in a microwell shaped to increase friction between the microwell wall and the cell contained in the microwell, according to some embodiments of the present invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

To address the limitations and new needs for the current cell-based HTS, a chip is provided for cell protrusion-based drug screening, according to an aspect of some embodiments of the present invention. Cell protrusions are crucial components contributed to cancer cell metastasis and the cytoskeletal protrusions enable cancer metastatic colonization. In some embodiments of the present invention, the chip is configured to be integrated with standard 96-well and 384-well plates and is configured to employ microfluidics technologies to be used to screen anti-metastasis drugs detecting by high-resolution fluorescent imaging of protrusion dynamics at the single cell precision. Since the cell protrusion is very sensitive to the drug with fast response time of less than one hour, the chip of the present invention enables to identify promising drugs that inhibit or slow down cell protrusion within hours. In addition, the chip of the present invention allows to provide quantitative information about drug treatment response, cell-cell interactions, and cell-extracellular matrix interactions at single cell level in a high-throughput manner.

In some embodiments of the present invention, the chip of the present invention be used to significantly accelerate neuron research, especially the bystander effect. The chip of the present invention is capable of high-efficiency single cells capture into highly ordered microwells via a user-friendly centrifugation method and the captured single cells can be connected to adjacent cells via synapses at uniform distances along the microchannel network. Furthermore, since the chip is an up-open platform, allowing integration with a microinjection unit, the captured single cells can be quickly treated and the effects on adjacent cells can be assessed.

In some embodiments of the present invention, the microwells are configured to capture and hold single cells and to restrain the cell movement during injection. It is critically important to hold the cell as even small movement during the drug injection will punctuate large hole on the cell membrane, which can lead to cell apoptosis. For this purpose, in some embodiments of the present invention, the microwells have angled shapes and textured surface. The angle can hold cell in place without movement during injection and the textured surface provides additional fraction between cell and the wall of the microwell, preventing cell rotation and potential escape from the well during injection needle piercing cell membrane.

Traditional injection methods require to hold a cell manually with one arm and operate the injector with the other arm followed by release of the cell and move to a next target cell. In the chip of the present invention, each well contains a single cell and includes features, such as angled shape and/or walls with textured surface, which anchor the cell at the angled corner of the microwell to restrain movement during injection and increase friction between cell and the well's wall. With the chip of the present invention, the need of cell holding arm is eliminated, which makes the injection process faster and less skill dependent. In addition, the cells are isolated in pre-defined positions, which enables automation of injection and tracking of the individual cells.

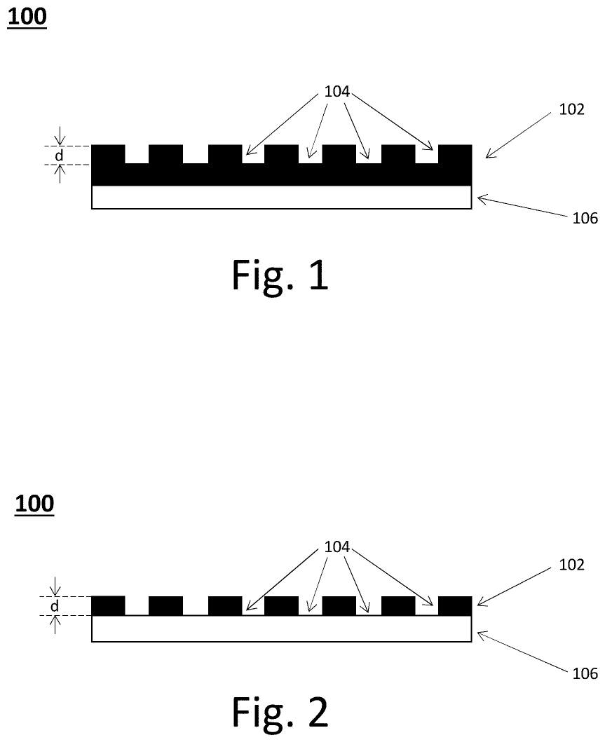

Referring now to the figures, FIG. 1 is a side cross sectional view of a networked cell-holder chip 100 with up-open microwells, according to some embodiments of the present invention.

The networked cell-holder chip 100 (hereinafter, also referred to as “chip”) includes a top layer 102 having a plurality of spaced apart microwells 104 which are open on top. Each microwell 104 has a depth d and is configured to hold an individual cell. As will be explained further below, each microwell 104 is connected to two to eight adjacent microwells via microchannels. The microchannel guide protrusions between cells in the microwells to join each other, and are smaller than the cell, therefore preventing movement of the cells through the microchannels. Only a single cell is loaded into each microwell 104. Cells spread their protrusions inside the microchannels. The microwells 104 do not pose a spatial constraint to cell morphology changes for culturing. The top layer 102 includes biocompatible material and is transparent to visible light, such as PDMS (polydimethylsiloxane), PMMA (poly (methyl methacrylate)), PC (polycarbonate), and PS (polystyrene), for example. In some embodiments of the present invention, the thickness of the top layer 102 is between 0.5 mm and 3 mm. In some embodiments of the present invention, the microwells are set into an array of parallel rows and the microchannels are straight channels connecting microwells in the same column and/or in the same row.

In some embodiments of the present invention, the top layer 102 is joined to a substrate 106. The substrate 106 is thin material that is transparent to visible light (such as glass or a rigid polymer, for example). In some embodiments of the present invention, the thickness of the substrate 106 is between 0.1 mm and 1.5 mm. The substrate 106 provides a rigid, flat base for supporting the top layer 102. The substrate 106 provides structural strength to the chip, and therefore makes the chip 100 easier to handle and move than the more compliant top layer 102.

In some embodiments of the present invention, as shown in FIG. 2 the microwells 104 of the top layer 102 are open both on the top and bottom. The bottoms of the microwells 104 are closed by the substrate 106.

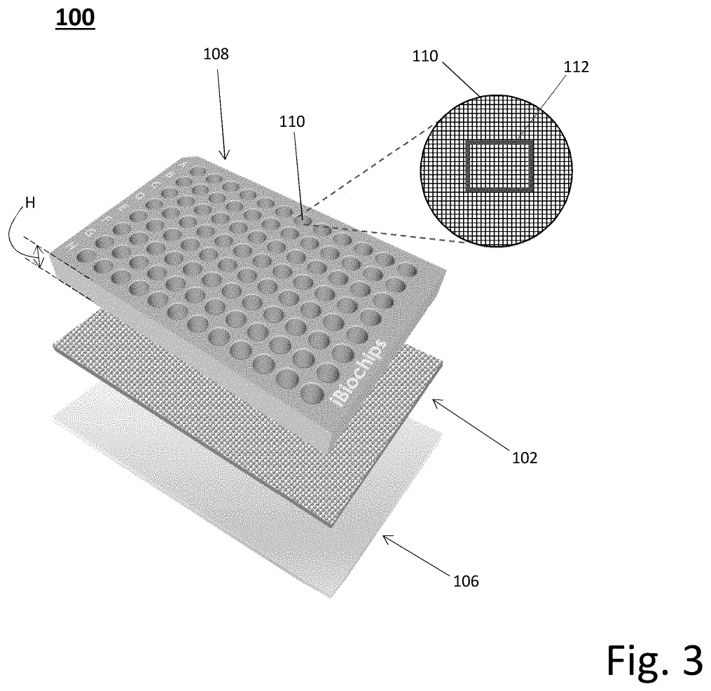

FIG. 3 is an exploded view of a networked cell-holder chip 100 of some embodiments of the present invention, joined to a bottomless well plate 108 and configured to receive a liquid solution from the bottomless well plate 108.

The top layer 102 of the chip 100 is joined to the bottom of a bottomless well plate (hereinafter, also referred to as “well plate”) 108 that is well known industry. The well plate is plate that includes a plurality of wells 100 that traverse the plate vertically and are open both on the top and bottom of the plate. The wells are configured to hold a liquid solution which includes cells that are to be captured in the microchannels and to enable transfer of the solution to the microwells. The well plate 108 is bonded with the top layer 102. The bonding may be performed by any method, such as plasma etching, adhesive bonding, or thermal bonding, for example.

In some embodiments of the present invention, at least the portion of well plate 108 which touches the solution includes biocompatible material, such as PDMS (polydimethylsiloxane), PMMA (poly (methyl methacrylate)), PC (polycarbonate), and PS (polystyrene), for example. The height H of well plate may be, for example, between 14 mm and 18 mm.

FIG. 3 also shows displays a top view of a single well 110 which leads to a plurality of microwells of the top layer 102. A portion 112 of the top layer 102 is also designated.

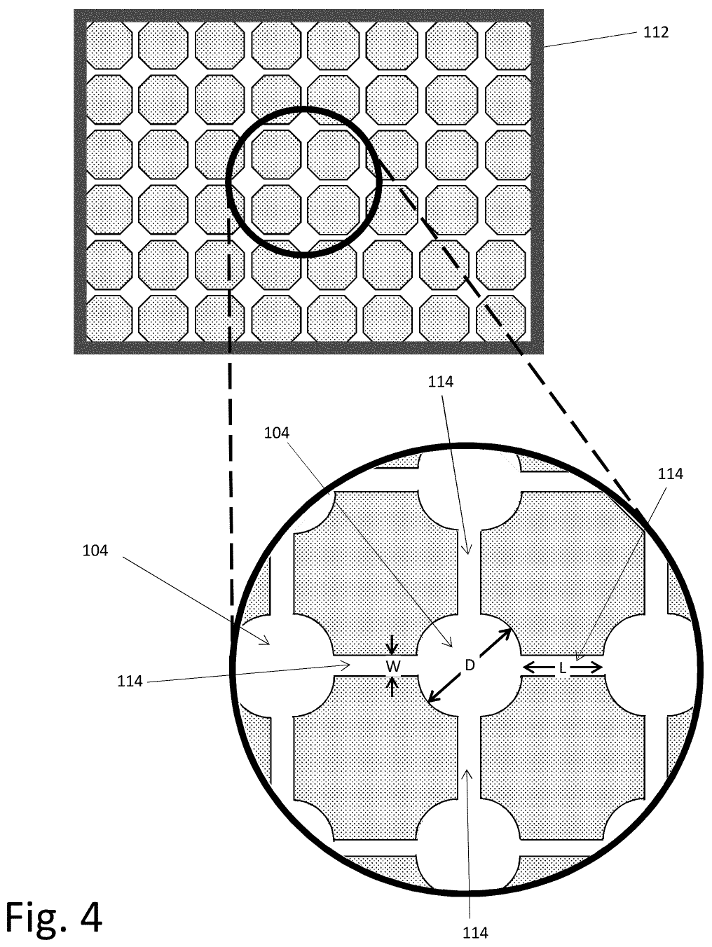

FIG. 4 is a top view of a portion 112 of the networked cell-holder chip 100 of the present invention in which each microwell 104 is connected to four nearby microwells 104 via respective microchannels 114. In a variant of the present invention, the microwells 104 are cylindrical and have a circular, oval, or elliptical top cross section. In another variant, the microwells 104 have polygonal top cross section. The top cross section of each well has a horizontal dimension D that divides the top cross section into two substantially equal parts. If the top cross section of the well is circular, the dimension D is the diameter.

As mentioned above, each microwell 104 is configured to hold a single cell and is sized according to the cell that the microwell is configured to hold. Each microchannel 114 has a length L and a width W. The width W is smaller than the size of the cells contained in the microwells 104, to prevent the cells from escaping the microwells 104 into the microchannels 114.

In some embodiments of the present invention, the horizontal dimension D of the microwells 104 is between 10-20 μm, while the depth d of the microwells 104 (as shown in FIGS. 1 and 2) is 10-20 μm. In some embodiments of the present invention, the width W of each microchannel 114 is 3-6 μm, the depth of each microchannel 114 is 10-20 μm, and the length L of each microchannel is 10-30 μm. It should be noted that the above-mentioned sizes may be designed according to the size and characteristics of the cells to be held by the microwells and the characteristics of the protrusions of the desired cell types.

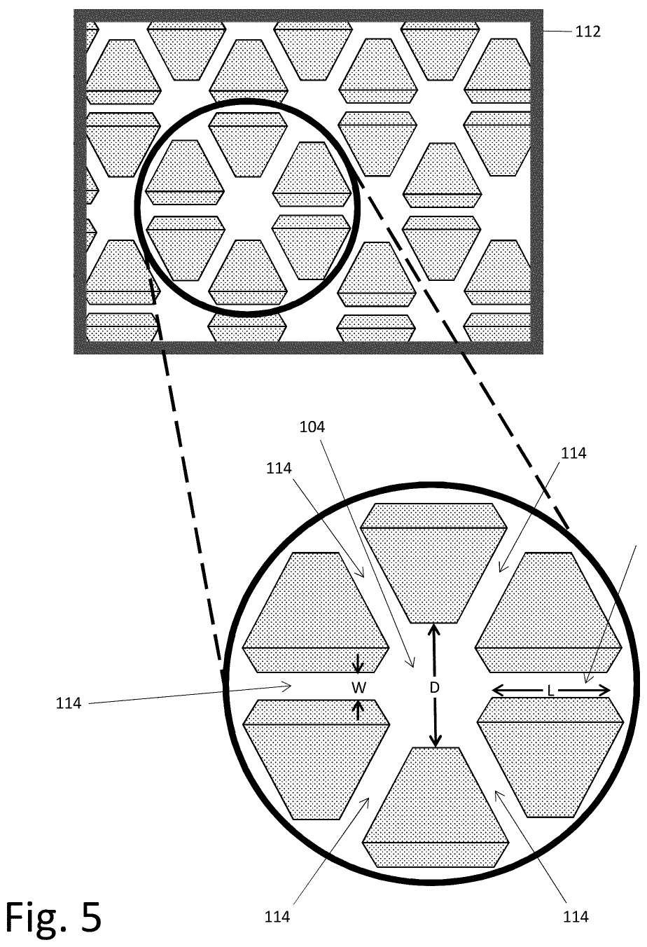

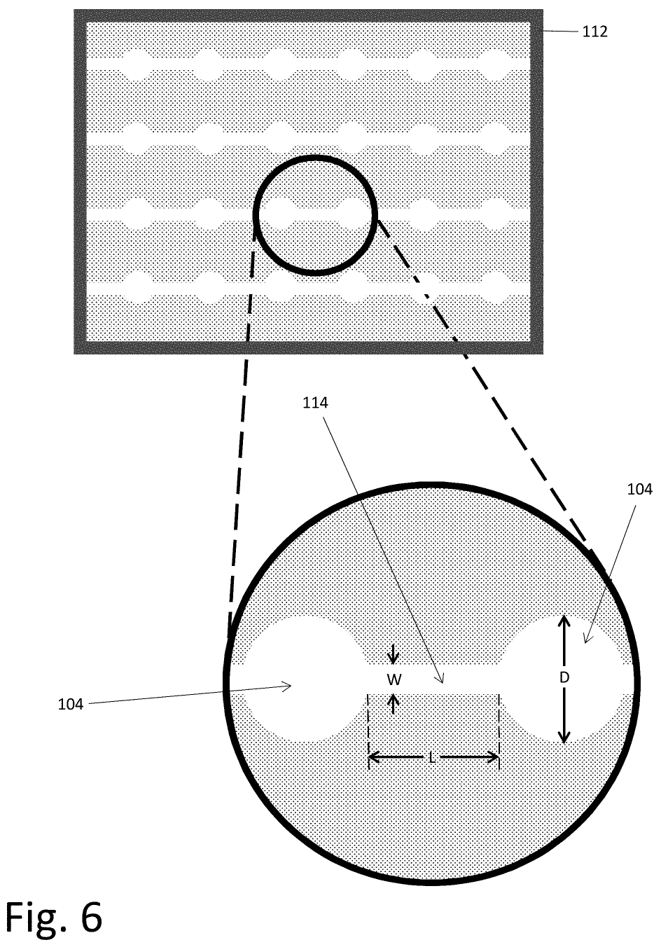

FIG. 5 is similar to FIG. 4, with the difference that in FIG. 5 each microwell 104 is connected to six other microwells via six respective microchannels 114. FIG. 6 is similar to FIG. 4, with the difference that in FIG. 6 each microwell 104 is connected to two other microwells via two respective microchannels 114.

FIGS. 7-13 illustrate steps of a method for fabricating a networked cell-holder chip, according to some embodiments of the present invention. The chip of the present invention is fabricated using photolithography and elastomer molding techniques.

The structure of the chip is first plotted with computer-aided design (CAD) program and then a photomask 204 is created by printing the CAD design on glass or quartz substrate. The CAD design plotted on photomask will be transferred to photoresistor layer, as will be explained further below.

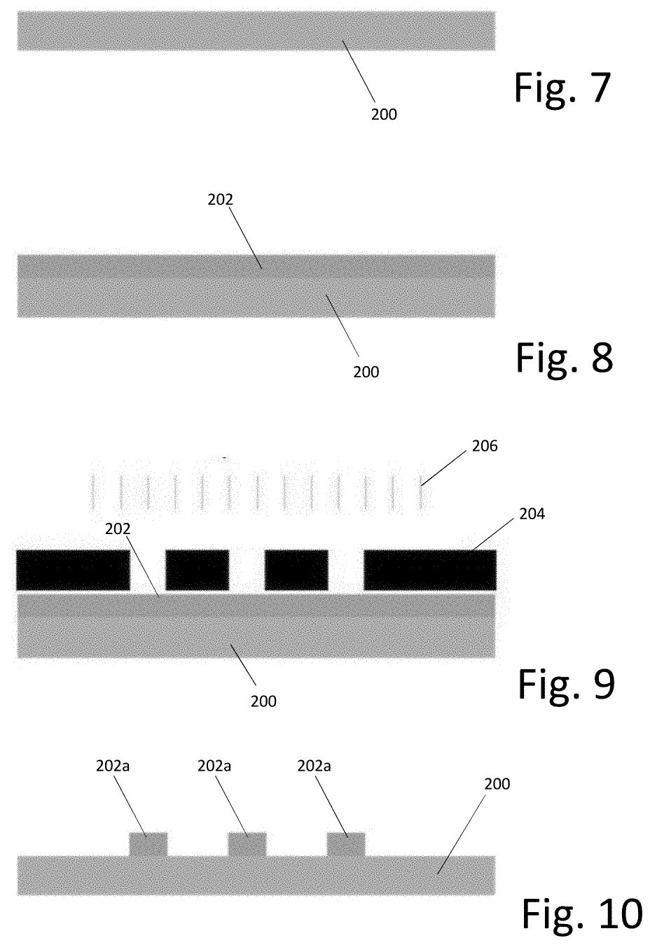

In FIG. 7, a wafer 200 is provided. The wafer 200 may be, for example, a silicon wafer. In FIG. 8 a photoresistor layer 202 is laid on the wafer 200. The photoresistor may include, for example SU-8 photoresist. The SU-8 photoresist may be spin-coated onto the silicon wafer at 500 rpm for 10 seconds with an acceleration of 100 rpm/s, then at 3,000 rpm for 30 s with an acceleration of 300 rpm/s. The wafer 200 may be then soft-baked, for example for about 10 minutes at about 95° C. The depth of the microwell and the microchannel are determined by the photoresist thickness. The spin coating and baking parameters can be varied to achieve desired thickness.

In FIG. 9, the photomask 204 is placed above photoresistor layer 202 and light 206 emitted from a light source is shined at the photoresistor layer 204 though the photomask 204. Sections 202a of photoresistor that are exposed to the light 206 harden, while those that are not exposed to the light 206 are washed away via a developer, as seen in FIG. 10. In a variant, the photoresistor layer is exposed to UV light of 200 mJ/cm² for 6 seconds, and post-exposure baking is performed immediately after for 1 minute at 65° C. and the for 4 minutes at 95° C. In a variant, the photoresistor is then developed in the developer for about 6 minutes, and then the wafer and photoresistor are hard-baked for 30 minutes at 150° C.

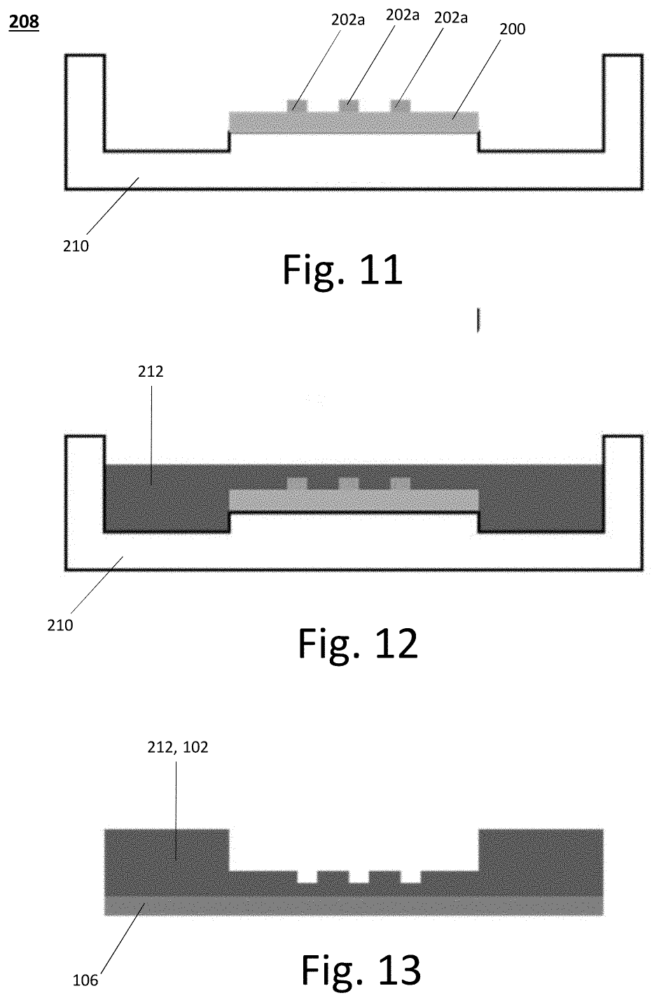

The hard-baked wafer 200 and developed photoresistor 202a serve as a mold 208, shown in FIG. 11. The mold 208 includes a basin 210 and wafer 200 joined to the developed photoresistor 202a. The basin 210 is configured for receiving and holding a liquid. The wafer 200 is joined to the inner base of the basin 210, such that the developed photoresistor sections 202a are on the side of the wafer 200 that is opposite to the side of the wafer that contact the basin 210.

In FIG. 12, a liquid 212, which will ultimately form the top layer 102 of FIGS. 1-3, is poured into the basin 210. The liquid 212 is poured in a quantity that enables the top layer to have a desired height. Depending on the desired height of the liquid, the developed photoresistor sections 202a may be fully covered by the liquid 212, or may partially protrude above the surface of the liquid 212. The liquid 212 is manipulated to harden into an elastic form and is then peeled off from the basin 210 to from the top layer 102, as seen in FIG. 13. The top layer 102 is the joined to the substrate 106.

In some embodiments of the present invention, the liquid 212 is a 10:1 mixture of a PDMS oligomer with a crosslinking prepolymer of the PDMS agent from a Sylgard™ 184 kit. The mixture is placed under vacuum for degassing, and is the poured into the basin 210 of the mold 208. The mixture is cured at 80° C. for 2 hours inside the mold 208 to assume a solid form. Once solid, the mixture is peeled off from the mold. Oxygen plasma is applied to the upper layer 102 and the thin substrate 106, and then the upper layer 102 and the thin substrate 106 are bonded together. Finally, the bottomless well plate is integrated to the bonded upper layer 102.

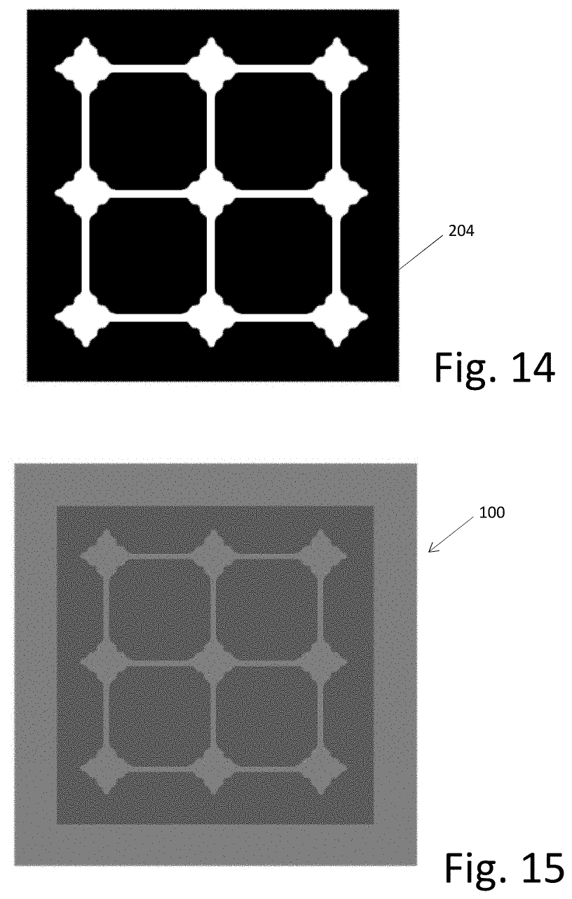

FIG. 14 is a top view of a photomask 204 used in the fabrication of the networked cell-holder chip, according to some embodiments of the present invention. FIG. 15 is top view illustrating the completed networked cell-holder chip 100, according to some embodiments of the present invention.

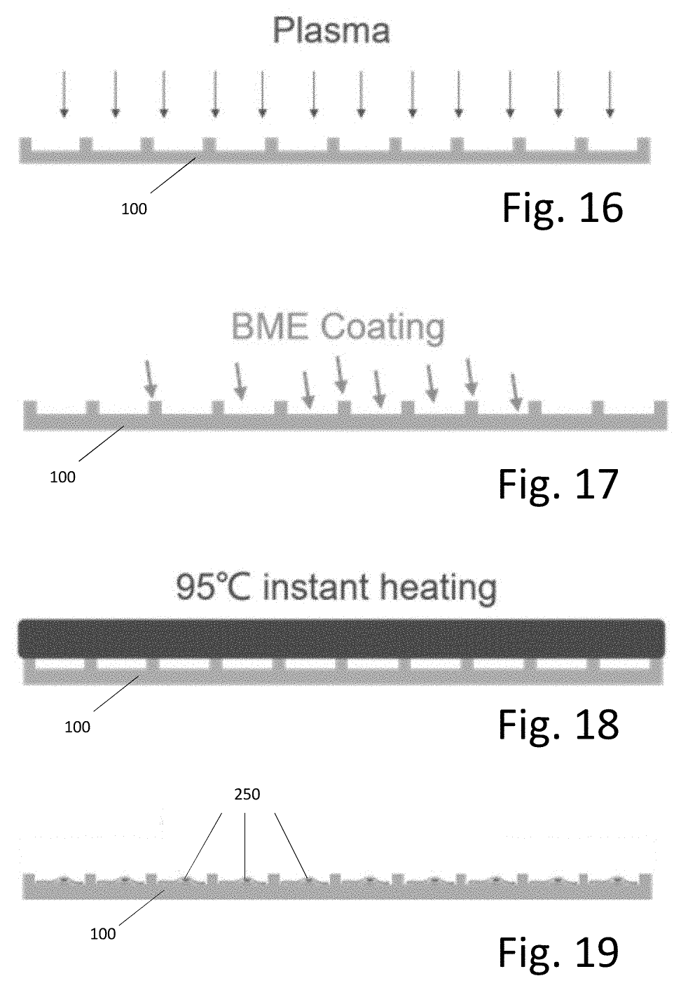

FIGS. 16-19 illustrates steps of a method for treating the networked cell-holder chip for adhesion of cells, according to some embodiments of the present invention.

In FIG. 16, the surface of the chip 100 is treated with oxygen plasma (1 min at an oxygen flow rate of 20 SCCM, a chamber pressure of 500 mtorr, and a power of 50 W). In FIG. 17, the surface of the chip 100 is covered with a droplet of Basement Membrane Extract (BME) and placed at 37° C. for 1 hour. After coating, the excessive liquid BME is removed. In FIG. 18, the chip 100 is moved onto a 95° C. digital dry bath (Bio-Rad) for 1 second to denature the BME coated on the surface of the chip 100. After the heating in the digital dry bath, invisible tape is used to peel off the excessive BME. In FIG. 19, cells 250 are introduced in the microwells of the chip 100.

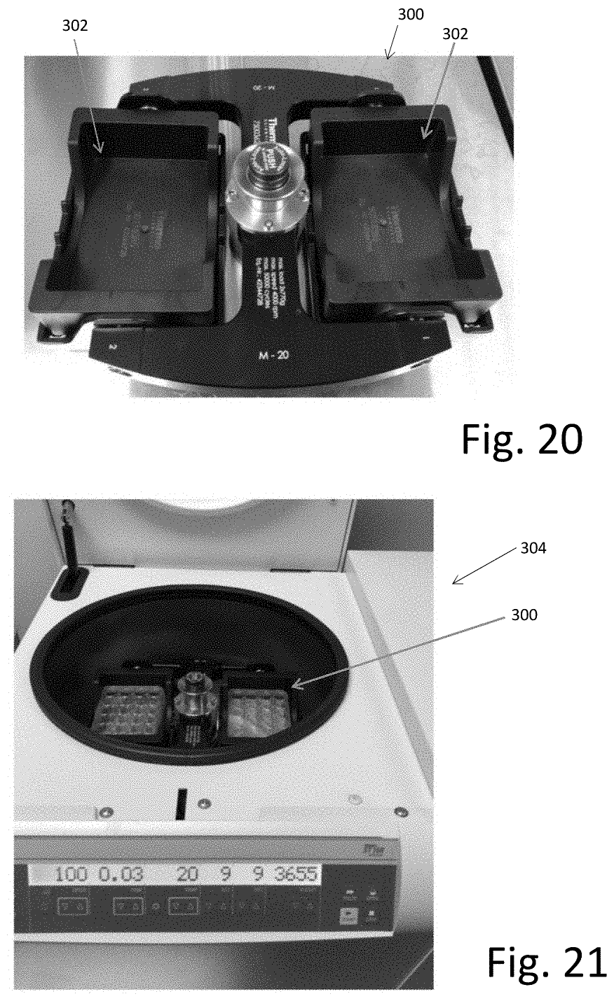

FIG. 20 illustrates a swinging bucket rotor 300 having receptors 302 upon which the chip and bottomless well plates are loaded, according to some embodiments of the present invention. FIG. 21 illustrates the swinging bucket rotor joined to a centrifuge 304 configured to control the rotation of the swinging bucket rotor 300, according to some embodiments of the present invention.

To load the cells into the chip of the present invention, a medium containing suspended cells is dropped onto the surface of the well plate of a chip of the present invention via a multichannel pipette or liquid handling system. In some embodiments of the present invention, 20-ml of the medium is dropped onto a chip of the present invention having a width of 86 mm, a length of 128 mm, and height of 14 mm. The chip is loaded on one of the receptors 302 of the bucket rotor 300. The bucket rotor is spun by the centrifuge 304 to drive the cells into the microwells of the chip. The inventors have experimented with different spinning modes. A non-limiting spinning mode that worked well for introducing 661 W cells into the microwells of the chip is as follows:

(i) 0 to 1000 rpm, acceleration=1

(ii) 1000 rpm for 1 min;

(iii) 1000 to 600 rpm, deceleration=1;

(iv) 600 to 0 rpm, deacceleration=9.

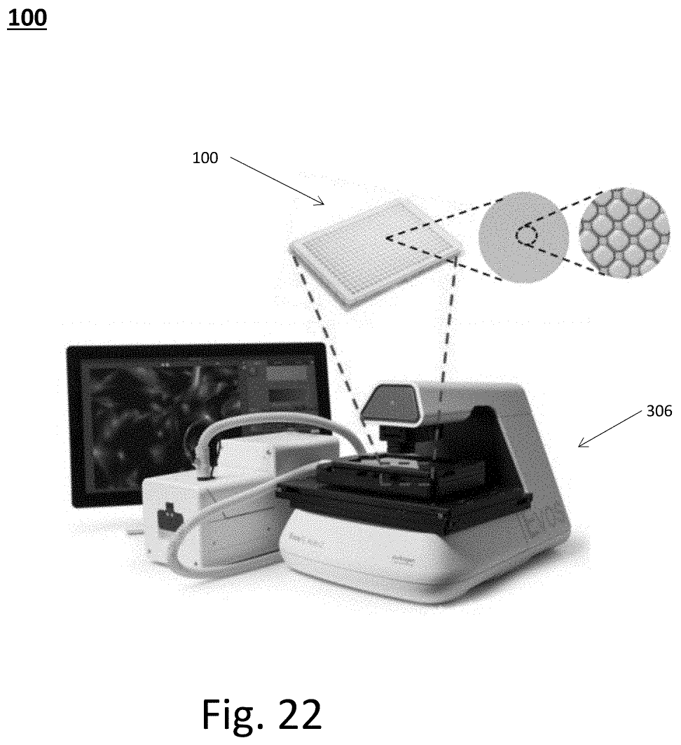

FIG. 22 illustrates an imaging system 306 configured for monitoring the cells in the chip, according to some embodiments of the present invention.

After spinning, the chip 100 is transferred to an inverted microscope 306, such EVOS FL Auto 2microscope manufactured by Thermo Fisher Scientific. Filter papers (e.g., manufactured by Whatman) are used to swipe away the unloaded cells. Finally, the cells are cultured at 37° C. in the chip 100 a humidified atmosphere with 5% CO2, to enable protrusions to extend in the microchannels. The cells are also stained (for example, with green fluorescent protein—GFP) to enhance visibility of the cells and protrusions.

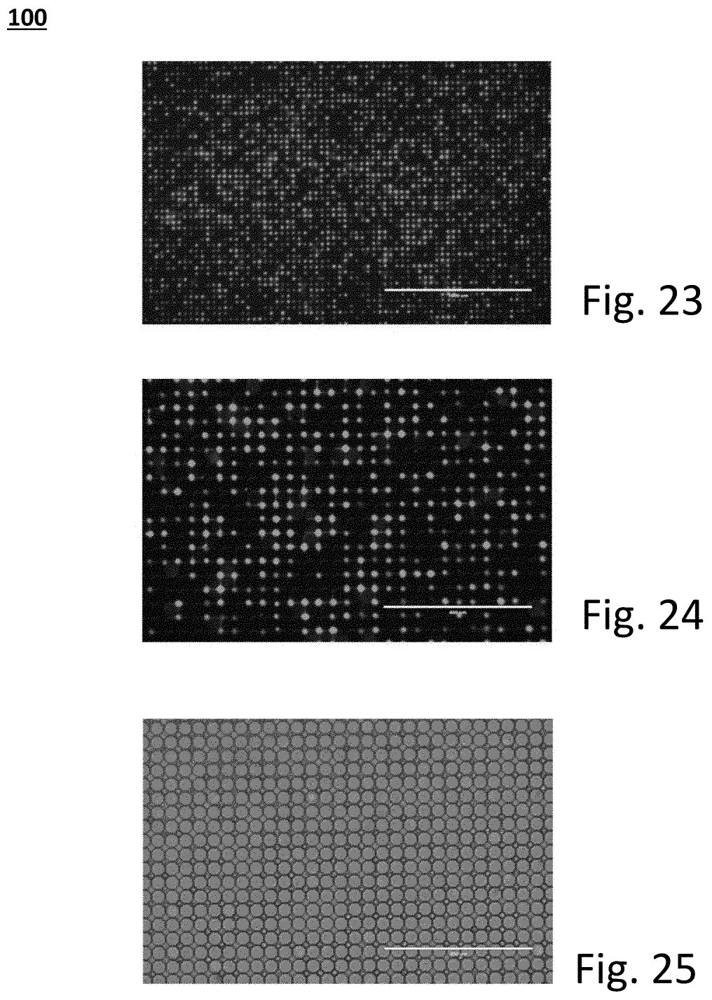

FIGS. 23-25 are photographs of representative fluorescence and bright images of captured GFP transfected cells in the chip of the present invention. The images are captured via the inverted microscope 306. Scale bars are 1 mm in FIGS. 23, and 400 μm in FIGS. 24 and 25.

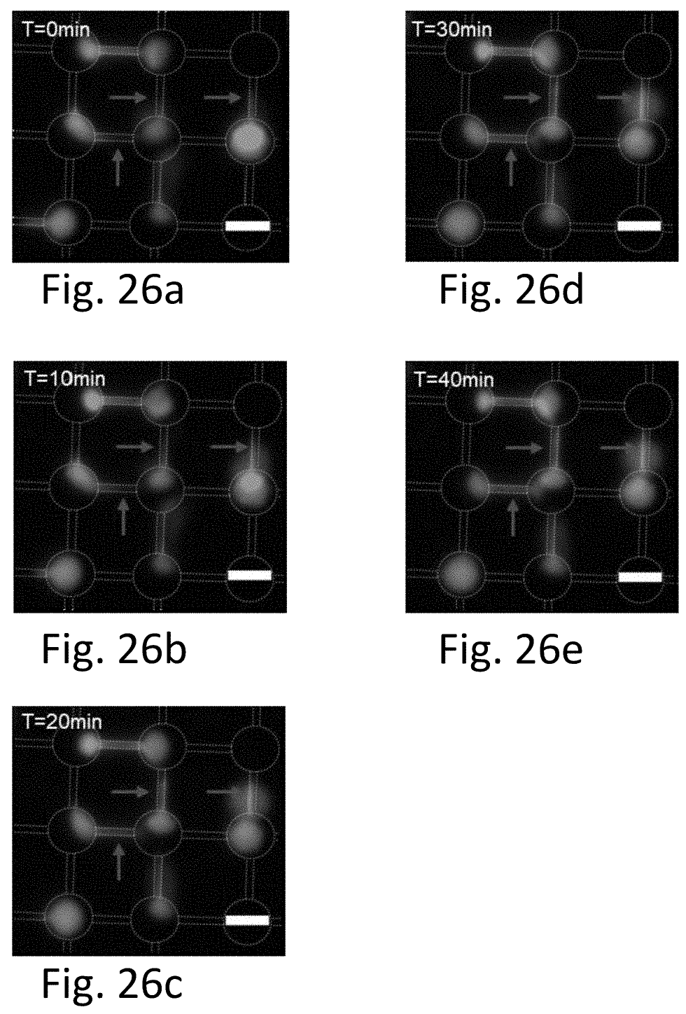

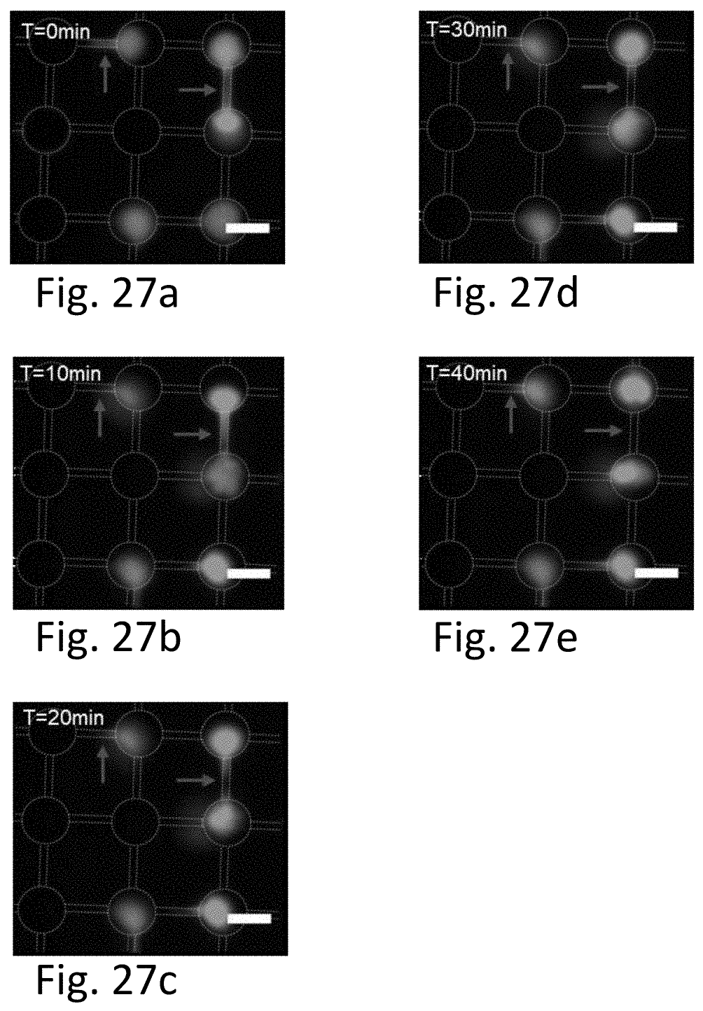

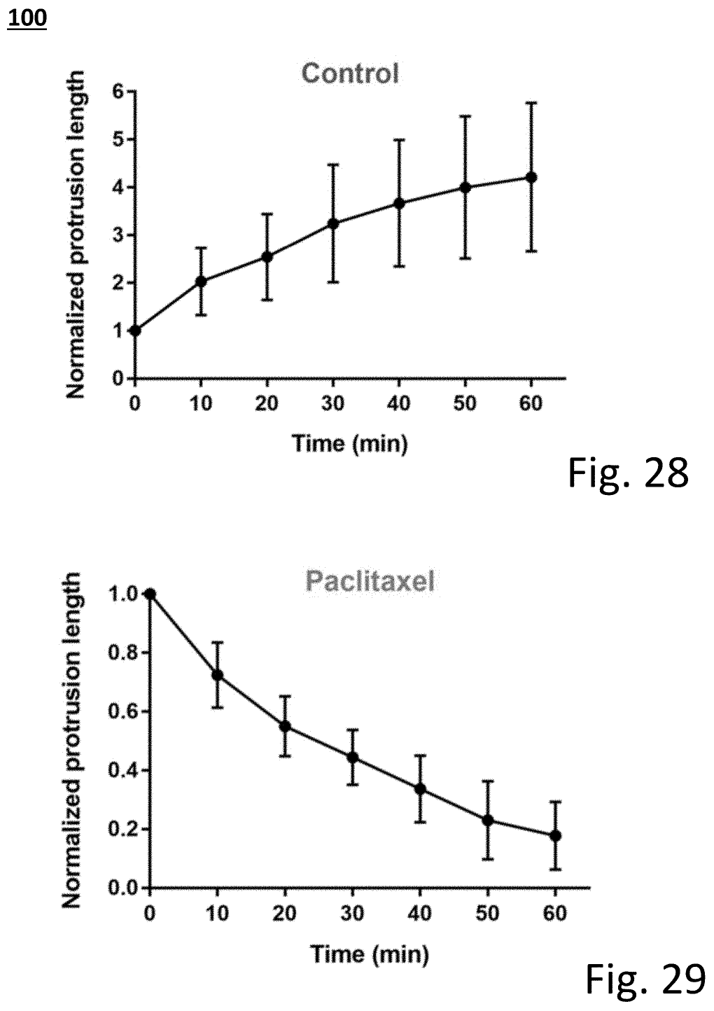

FIGS. 26a-26e are time course images of breast cancer cells in the chip of the present invention, illustrating the development of the protrusions when the breast cancer plates are left untreated. FIGS. 27a-27e are time course images of breast cancer cells in the chip of the present invention, illustrating the reduction of the protrusions when the breast cancer cells are treated with an anti-cancer drug (paclitaxel). FIG. 28 is a graph illustrating normalized length of cell protrusion of untreated breast cancer cells over time. FIG. 29 is a graph illustrating normalized length of cell protrusion of breast cancer cells treated with an anti-cancer drug (paclitaxel) over time.

The graph of FIG. 28 was obtained using a sample of 64 cells, while the graph of FIG. 29 was obtained using a sample of 51 cells. The loaded breast cancer cells in both chips were incubated overnight. In the chip that was to be treated with the drug, the medium was replaced by a fresh culture medium mixed with paclitaxel concentration of 0.5 μM, after the incubation period. When left untreated, the protrusions of the breast cancer cells grow, increasing the growth of the cancer, as seen in FIG. 28. It can be clearly seen that exposing the cancer cells to paclitaxel reduces the length of the protrusions in FIG. 29. FIGS. 26a through 29 show that the chip of the present invention reduces the time required for testing a drug on cells. In the case of breast cancer cells, the effects of the drug on the cancer cells were clear within one hour.

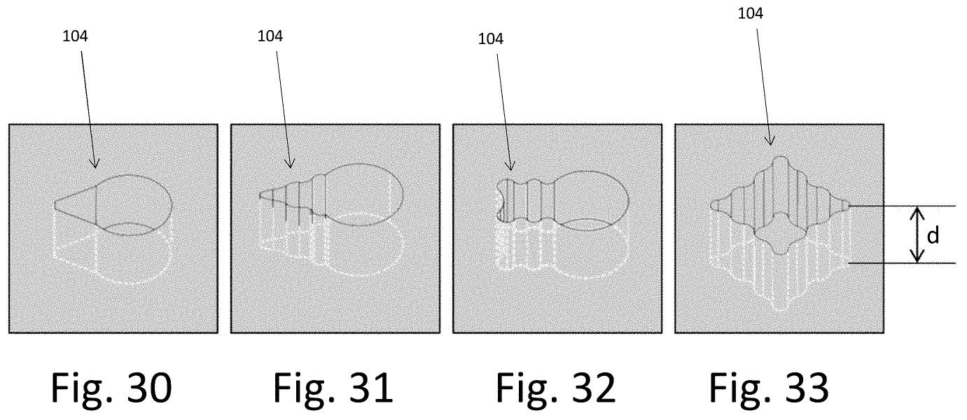

FIGS. 30-33 illustrate examples of shapes of microwells in the chip for increasing friction between the microwell and the cell contained within, according to some embodiments of the present invention.

In some embodiments of the present invention, the microwells 104 in the chip have walls are shaped to increase friction between the microwell and the cell contained within. This friction decreases the movement of the cell within the microwells and therefore facilitates microinjection in the cells.

In some embodiments of the present invention, each microwell, has a top cross-section having a perimeter which includes one or more inner concave angles and one or more inner convex angles. In some embodiments of the present invention, at least one of the convex angles is an acute angle. These shapes of the top cross-section are determined by the shape of the photomask used to fabricate the chip. In some embodiments of the present invention, the perimeter of the top cross section has a plurality of inner concave angles and inner convex angles, such that a plurality of extensions protrude inwards from the perimeter, as seen, for example in FIGS. 31-33. Thanks to the advances in printing, the photomask has sub-micrometer spatial resolution. Thus, the complex shapes of the microwells can be directly printed on the photomask and the pattern is transferred to photoresistor.

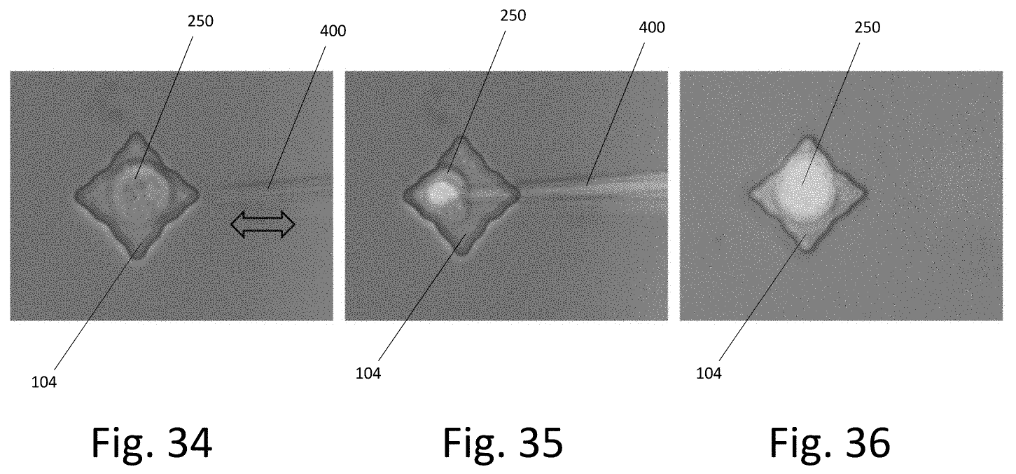

FIGS. 34-36 are photographs illustrating a microinjection performed on a cell 250 in a microwell 104 having a shape configured to increase friction between the microwell's wall and the cell 250 contained in the microwell, according to some embodiments of the present invention.

In FIG. 34, the cell 250 is in the microwell 104 and the injection needle 400 is outside the microwell. In FIG. 35, the injection needle gently pushes the cell 250 to a corner of microwell 104 and the gripping surface of the wall holds the cell 250 in position during injection by the friction between cell membrane and the wall of the microwell. Next, the injection needle advances to pierce the cell membrane and injects the designed amount of liquid into the cell 250. Lastly, in FIG. 26, the injection 400 needle is retrieved and the successful injection can be confirmed in the fluorescence of the cell 250.

What is claimed is:

1. A cell holder chip, comprising a top layer having a plurality of spaced apart microwells and a plurality of microchannels, each microwell being open on top and configured to hold a single cell, and each microwell being connected to at least two nearby microwells via respective microchannels;
wherein the microchannels are sized to enable protrusions from the cells to spread therethrough and have widths smaller than the cells to preventing the cells from entering the microchannels.

2. The cell holder chip of clam 1, wherein the top layer is transparent to visible light.

3. The cell holder chip of claim 1, further comprising a substrate bonded to a bottom of the top layer.

4. The cell holder chip of claim 2, wherein the substrate is rigid.

5. The cell holder chip of claim 2, wherein the substrate is made of material that is transparent to visible light.

6. The cell holder chip of claim 2, wherein the microchannels are open on both the top and bottom of the top layer, and the substrate closes the microchannels at the bottom of the top layer.

7. The cell holder chip of claim 1, further comprising a bottomless well plate joined to a top of the top layer, the bottomless well plate comprising a plurality of wells that traverse the plate vertically and are open both on the top and bottom of the bottomless well plate, the wells being configured to hold a liquid solution which includes cells that are to be captured in the microchannels and to enable transfer of the solution to the microwells.

8. The cell holder chip of claim 1, wherein:
each microwell is connected to two nearby microwells via respective microchannel; or
each microwell is connected to four nearby microwells via respective microchannel; or
each microwell is connected to six nearby microwells via respective microchannel; or
each microwell is connected to eight nearby microwells via respective microchannel.

9. The cell holder chip of claim 1, wherein the microwells are set into an array of parallel rows, and the microchannels are straight channels connecting microwells in the same column and/or in the same row.

10. The cell holder chip of claim 1, wherein at least one of the microwells has a top cross-section has a perimeter which includes at least one inner concave angle and at least one inner convex angle, for providing increased friction between the microwell and the cell contained within.

11. The cell holder chip of claim 10, wherein the at least one inner convex angle is acute.

12. The cell holder chip of claim 10, wherein the at least one of the microwells has the top cross-section has the perimeter which includes a plurality of inner concave angles and a plurality of inner convex angle, such that a plurality of extensions are formed, protruding inward from the perimeter, to provide increased friction between the microwell and the cell contained within.

13. The cell holder chip of claim 12, wherein at least one of the inner convex angles is acute.
